(19) United States
(12) Patent Application Publication
(10) Pub. No.: US 2014/0184829 A1
(43) Pub. Date: Jul. 3, 2014

(54) Bluetooth Remote-Control Photographing Device

(71) Applicant: Zhengliang Li, Shanghai (CN)

(72) Inventor: Zhengliang Li, Shanghai (CN)

(21) Appl. No.: 13/981,311

(22) PCT Filed: Jul. 10, 2012
(86) PCT No.: PCT/CN12/78411

§ 371 Date: Jul. 23, 2013

(30) Foreign Application Priority Data
May 25, 2012 (CN) 201220241715.2

(51) Int. Cl. H04N 5/232; H04W 4/00

(52) U.S. Cl. CPC H04N 5/23203; H04W 4/008
USPC 348/207.11

(57) ABSTRACT

A Bluetooth remote-control photographing device composed of a photographing device body and a Bluetooth remote controller controlling the photographing device body; a Bluetooth module is electrically connected on the circuit board of the said photographing device body; with the said Bluetooth, the said photographing device body wirelessly connected with the said Bluetooth remote controller. The Bluetooth remote-control photographing device realizes control of photographing device by the Bluetooth remote controller.

### BACKGROUND OF THE INVENTION

This utility model involves digital products, especially a Bluetooth remote-control digital camera, a smartphone with camera and video camera functions, and a tablet computer.

With the development of social economy and the continuous improvement of people's living level, digital products, especial the digital camera, are required to go with the flow. The improved living level nowadays enables us to take travel and leisure as a type of relaxation and recreation after work. In general, lots of people would use their cameras or cell phones to take some photos of tour sceneries, and take the photos back home to share with their families and friends. However, existing digital cameras or cell phones require users to press the shutter keys to take photos. When they need to take photos of themselves, they can only ask others for help or use the delay function, either of which is not convenient. This inconvenience of use fails to integrate users into beautifully sceneries, bring regrets to tourists or even affecting the relaxed and happy moods of the tourists.

### BRIEF SUMMARY OF THE INVENTION

This utility model is designed to effectively overcome the shortcomings of the above-mentioned technology, and provides a Bluetooth remote-control photographing device control by wireless Bluetooth. With wireless Bluetooth control, this photographing device realizes photo taking or long-distance selfie taking.

Here is the method to realize the technical solution of this utility model: A Bluetooth remote-control photographing device, composed of a photographing device body and a Bluetooth remote controller controlling the photographing device body; a Bluetooth module is electrically connected on the circuit board of the said photographing device body; with the said Bluetooth, the said photographing device body wirelessly connected with the said Bluetooth remote controller.

The said photographing device body is a digital camera, a cell phone with camera and/or video camera functions or a tablet computer.

The benefit of this utility model is: With a Bluetooth module connected on the circuit boards of existing devices with camera and/or view camera functions, such as camera, cell phone, and tablet computer, and an equipped Bluetooth remote controller which connects with the photographing device Bluetooth through the Bluetooth module, this utility model realizes control of photographing device by the Bluetooth remote controller. Therefore, when you need to take a selfie or a group photo, you do not have to ask others for help or enable photographing delay function. You just directly fix the photographing device and adjust the framing, and then press the wireless control shutter key on the Bluetooth remote controller to take the photo. You can also take a selfie from a distance more than ten meters or longer by remotely controlling the digital camera, with easy operation, safe and reliable control, and good applicability.

### BRIEF DESCRIPTION OF THE DRAWINGS

FIG. 1 shows the functional block diagram of this utility model.

### DETAILED DESCRIPTION OF THE INVENTION

The following gives a further description about this utility model with figures and examples.

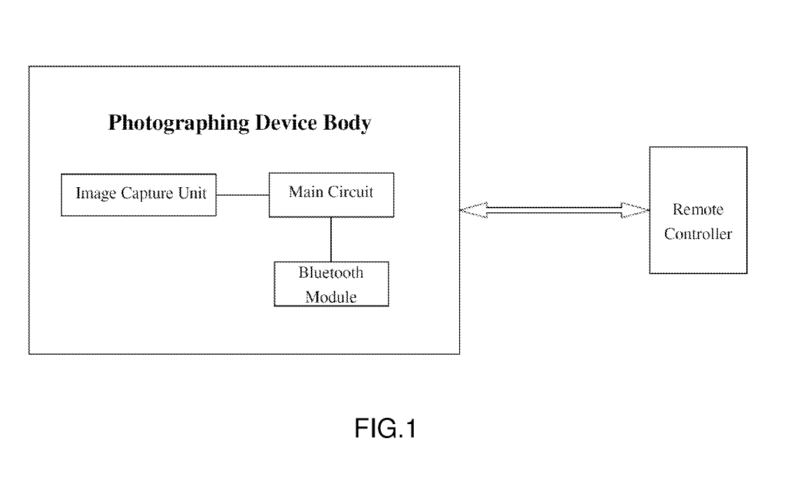

As shown in FIG. 1, this utility model reveals a Bluetooth remote-control photographing device, which is composed of a photographing device body and a Bluetooth remote controller controlling the photographing device body; a Bluetooth module is electrically connected on the circuit board of the said photographing device body; with the said Bluetooth, the said photographing device body wirelessly connected with the said Bluetooth remote controller; the main circuit also connects with the image capture unit used for camera or video camera.

The said photographing device body can be a digital camera, a cell phone with camera and/or video camera functions or a tablet computer.

With a Bluetooth module connected on the circuit boards of existing devices with camera function, such as camera, cell phone, and tablet computer, and an equipped Bluetooth remote controller which connects with the photographing device Bluetooth through the Bluetooth module, this utility model realizes control of photographing device by the Bluetooth remote controller. Therefore, when you need to take a selfie or a group photo, you do not have to ask others for help or enable photographing delay function. You just directly fix the photographing device and adjust the framing, and then use the Bluetooth remote controller in hand to transmit a control signal to the Bluetooth module. The Bluetooth module transmits this control signal to the main circuit, and controls the image capture unit to take the photo after the main circuit processes this control signal. You can also take a selfie from a distance more than ten meters or longer by remotely controlling the digital camera, with easy operation, safe and reliable control, and good applicability.

The contents mentioned above only describes a good implementation example of this utility model, and the above specific implementation example does not limit this utility model. All kinds of transformations and modifications can be made within the scope of technological thoughts of this utility model. All embellishments, modifications or equivalent replacements by ordinary technicians in this field base on the above description are within the scope of protection for this utility model.

What is claimed is:

1. A Bluetooth remote-control photographing device, with the following features: The device is composed of a photographing device body and a Bluetooth remote controller controlling the photographing device body; a Bluetooth module is electrically connected on the circuit board of the said photographing device body; with the said Bluetooth, the said photographing device body wirelessly connected with the said Bluetooth remote controller.

2. The Bluetooth remote-control photographing device described based on claim 1 has the following feature: The said photographing device body is a digital camera, a cell phone with camera and/or video camera functions or a tablet computer.
